(19) United States
(12) Patent Application Publication
(10) Pub. No.: US 2013/0214186 A1
(43) Pub. Date: Aug. 22, 2013

(54) PRESSURE REGULATING VALVE

(71) Applicants: Paulo Jorge Ferreira Goncalves, Frankfurt Am Main (DE); Michele Musci, Stuttgart (DE); Helmar Gruhl, Steinheim An Der Murr (DE)

(72) Inventors: Paulo Jorge Ferreira Goncalves, Frankfurt Am Main (DE); Michele Musci, Stuttgart (DE); Helmar Gruhl, Steinheim An Der Murr (DE)

(73) Assignee: ROBERT BOSCH GMBH, Stuttgart (DE)

(21) Appl. No.: 13/881,403

(22) PCT Filed: Sep. 20, 2011
(86) PCT No.: PCT/EP2011/066316

§ 371 Date: Apr. 25, 2013

(30) Foreign Application Priority Data
Oct. 29, 2010 (DE) 102010043097.8

(51) Int. Cl. F02D 41/22

(52) U.S. Cl. CPC F02D 41/22
USPC 251/129.2

(57) ABSTRACT

Proposed is a pressure regulating valve (10) for opening and closing an outlet of a high-pressure accumulator (12) for an injection device for internal combustion engines. The pressure regulating valve (10) has a valve element (18) which can be actuated by a magnet actuator (17). The magnet actuator (17) acts, by means of an armature (31), on a closing element (29) which closes off or opens up a hydraulic connection from the high-pressure accumulator (12) to a valve chamber (26), wherein the valve chamber (26) is hydraulically connected to a low-pressure port (15). The armature (31) has an armature plate (32) and an armature pin (33), wherein the armature plate (32) is arranged in a movable manner in an armature chamber (44). The armature chamber (44) is hydraulically connected via a return connection (50) to the valve chamber (26).

### BACKGROUND OF THE INVENTION

During operation of a self-ignition internal combustion engine having a high-pressure accumulator (common rail), the fuel system pressure in the high-pressure accumulator is maintained substantially constant by means of a pressure regulating valve. As soon as the pressure in the high-pressure accumulator exceeds the system pressure, the pressure regulating valve opens; when the pressure has fallen back below the system pressure, the pressure regulating valve closes. It is thereby ensured that the injection of fuel into the cylinders of the internal combustion engine takes place under constant conditions. If the fuel pressure in the high-pressure accumulator falls below the vapor pressure of the air dissolved in the fuel, the air out-gasses, so that a gas phase is also contained in the high-pressure accumulator in addition to the liquid fuel. When the internal combustion engine is started, the gas contained in the high-pressure accumulator must then be compressed by the high-pressure pump, so that the pressure necessary for operation builds up in the high-pressure accumulator. To achieve this, depending on the starting temperature of the internal combustion engine, several engine revolutions are required, causing delayed starting. In order to allow the air contained in the high-pressure accumulator to out-gas, it is provided that the pressure regulating valve is set to the open state when the engine is switched off

A pressure regulating valve in which the pressure regulating valve is opened—that is, a connection from the high-pressure accumulator to a low-pressure line is opened by a closing element—when the internal combustion engine is stationary is known from DE 10 2004 002 964 A1. For this purpose the pressure regulating valve includes a magnetic actuator which is energized in order to close the closing element, an armature positioning the closing element in a valve seat. In order to open the closing element there is provided a spring element acting against the magnetic force of the magnetic actuator and thereby moving the armature and an armature pin fastened thereto in the opening direction, whereby the closing element lifts from the valve seat and opens a hydraulic return connection between the high-pressure accumulator and the low-pressure line. The hydraulic return connection to the low-pressure line is effected from a valve chamber arranged downstream of the valve seat, from which valve chamber bores branch off laterally and open into a low-pressure line in the housing of the high-pressure accumulator.

### SUMMARY OF THE INVENTION

The pressure regulating valve has the advantage that the closing element executes a rapid opening stroke and remains in a stable position when in the open position. This is possible because both sides of the armature are exposed to the same pressure and the armature is therefore pressure-balanced. As a result, pressure fluctuations in the return line have no effect on the armature. In addition, through the arrangement of the armature plate in the armature chamber, damping of the armature during the opening phase is achieved.

According to a first embodiment, the hydraulic return connection is implemented by a connecting bore between valve chamber and armature chamber formed in the armature pin, which connecting bore is preferably configured as a blind hole with a transverse bore branching therefrom.

According to a second embodiment, the hydraulic return connection is implemented by at least one bore which passes through the valve housing and is connected at one end to the valve chamber and at the other end to the armature chamber. In this case the bore may open directly or indirectly into the valve chamber and into the armature chamber.

According to a third embodiment, the hydraulic return connection is formed by at least one channel worked into the piston guide and/or into the armature pin. The channel can be formed especially simply by at least one axially-disposed groove worked into the piston guide and/or into the armature pin. Advantageously, four axially disposed grooves distributed uniformly around the circumference of the armature pin form the axially-disposed channels, a land being implemented between each two adjacent grooves and forming with its outer face a guide surface inside the piston guide.

As a result of an arrangement of an outlet throttle connected downstream of the armature chamber, the effect of flow fluctuations between valve chamber and low-pressure line can be suppressed and the occurrence of cavitation at the valve seat or at the closing element is reduced. Optionally, the outlet may also be connected directly after the valve chamber.

### BRIEF DESCRIPTION OF THE DRAWINGS

An exemplary embodiment of the invention is explained in more detail in the following description and is represented in the drawing, in which:

FIG. 1 is a sectional view through a pressure regulating valve according to the invention in a first exemplary embodiment;

FIG. 2 is a sectional view through a pressure regulating valve according to the invention in a second exemplary embodiment;

FIG. 3 is a sectional view through a pressure regulating valve according to the invention in a third exemplary embodiment, and

FIG. 4 is a sectional view through the pressure regulating valve along the line II-II in FIG. 3.

### DETAILED DESCRIPTION

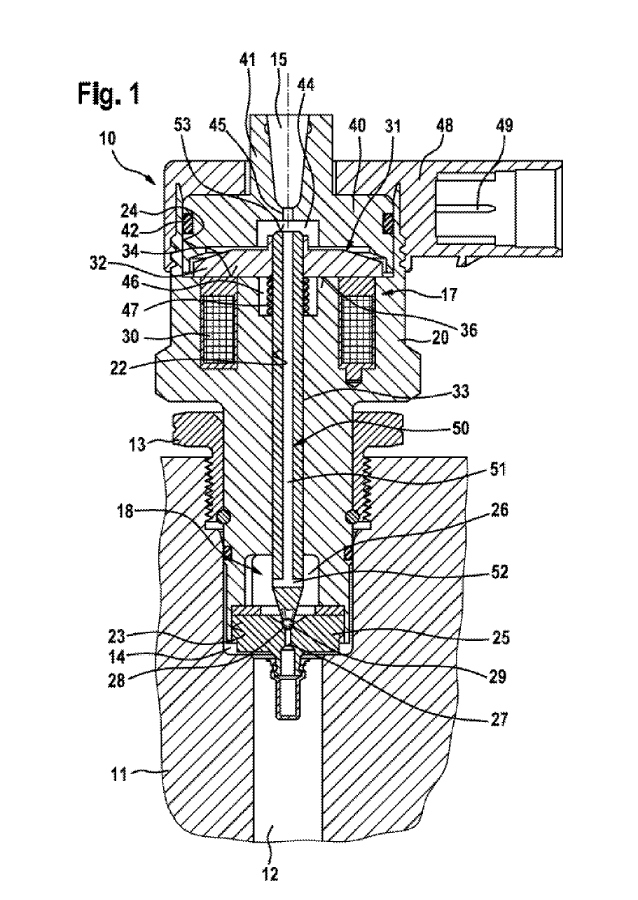

The pressure regulating valve 10 shown in FIGS. 1, 2 and 3 is inserted by means of a threaded bush 13 in a receiving chamber 14 in a housing 11 of a high-pressure accumulator 12 of a fuel injection device. In this case the pressure regulating valve 10 closes or opens a hydraulic connection from the high-pressure accumulator 12 to a low-pressure port 15 which is connected to a low-pressure line (not shown) leading back to a fuel reservoir (also not shown).

The pressure regulating valve 10 includes a magnetic actuator 17 and a valve element 18, the magnetic actuator 17 actuating the valve element 18. The magnetic actuator 17 and the valve element 18 are arranged in a valve housing 20 which comprises a piston guide 22, a valve part receptacle 23 and a receptacle 24 on the connection side.

The valve element 18, which comprises a valve part 25 and a closing element 29, is arranged in the valve part receptacle 23. The valve part 25 delimits a valve chamber 26 via a spacer ring. A throttle bore 27 hydraulically connecting the valve chamber 26 to the high-pressure accumulator 12 passes through the valve part 25. Furthermore, a valve seat 28 for the closing element 29 is formed in the valve part 25. The valve chamber 26 is arranged downstream of the valve seat 28, the closing element 29 being arranged inside the valve chamber 26.

The magnetic actuator 17 with a magnet coil 30 and an armature 31 is arranged in the receptacle 24 on the connection side, the magnet coil 30 acting on the armature 31. The armature 31 is configured with an armature plate 32 and an armature pin 33, the armature pin 33 being rigidly connected to the armature plate 32 and acting on the closing element 29. The armature pin 33 is guided in an axially displaceable manner in the piston guide 22, the piston guide 22 passing axially through the valve housing 20.

The magnet coil 33 forms with the surrounding housing part of the valve housing 20 a magnet core with a magnet core end face 34, against which the armature plate 23 rests with an armature face 36 when the magnet coil 30 is energized.

A connecting piece 40 with a connecting flange 41 is further inserted in a hydraulically sealed manner by means of a sealing ring 42 in the receptacle 24 on the connection side, the low-pressure port 15 being formed in the connecting flange 41. An armature chamber 44 in which the armature plate 32 is arranged axially movably is formed between the connecting piece 40 and the magnet core end face 34. In the present exemplary embodiment, the armature chamber 44 is connected hydraulically to the low-pressure port 15 via a discharge throttle 45. However, it is also possible to connect the valve chamber 26 to the low-pressure port 15. Adjoining the armature chamber 44 is a spring chamber 46 which is worked into the magnet core end face 34 and receives a compression spring 47 which acts on the magnet armature 31 in the opening direction of the closing element 29. The connecting piece 40 is retained on the valve housing 20 by means of a surrounding injection molding 48 containing electrical plug-in contacts 49 for the magnet coil 30.

In order to arrange the armature 31 in a pressure-balanced manner inside the armature chamber 44 and the valve chamber 26, a hydraulic return connection 50 is provided between the valve chamber 26 and the armature chamber 44. As a result of the hydraulic return connection 50 between the valve chamber 26 and the armature chamber 44, the two opposite end faces, of the armature plate 32 inside the armature chamber 44 and of the armature pin 33 inside the valve chamber 26, are exposed to the same pressure, so that the armature 31 is axially movable in a substantially pressure-balanced manner.

According to the exemplary embodiment in FIG. 1, the hydraulic return connection 50 is formed by a blind bore 51 passing through the armature pin 33 and a transverse bore 52 branching therefrom. The blind bore 51 opens at one end face 53 into the armature chamber 44. The transverse bore 52 opens laterally into the valve chamber 26. Through the return bore 50 formed in this way, the valve chamber 26 is connected via the armature chamber 44 to the return line connected to the return port 15.

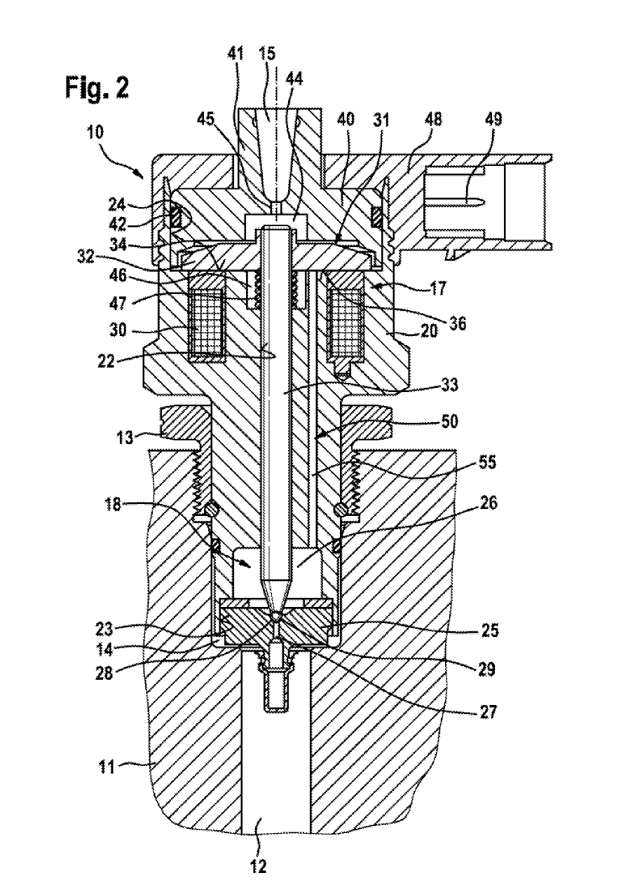

According to the exemplary embodiment in FIG. 2, the hydraulic return connection 50 is implemented as a bore 55 passing, for example axially, through the valve housing 20 and opening at one end into the valve chamber 26 and at the other end in the armature chamber 44 at the magnet core end face 34. The other end of the bore 55 may also, however, open into the spring chamber 46, which in turn is connected hydraulically to the armature chamber 44. As a result of the return bore 50 formed in this way, the valve chamber 26 is connected via the armature chamber 44 to the return line connected to the return port 15.

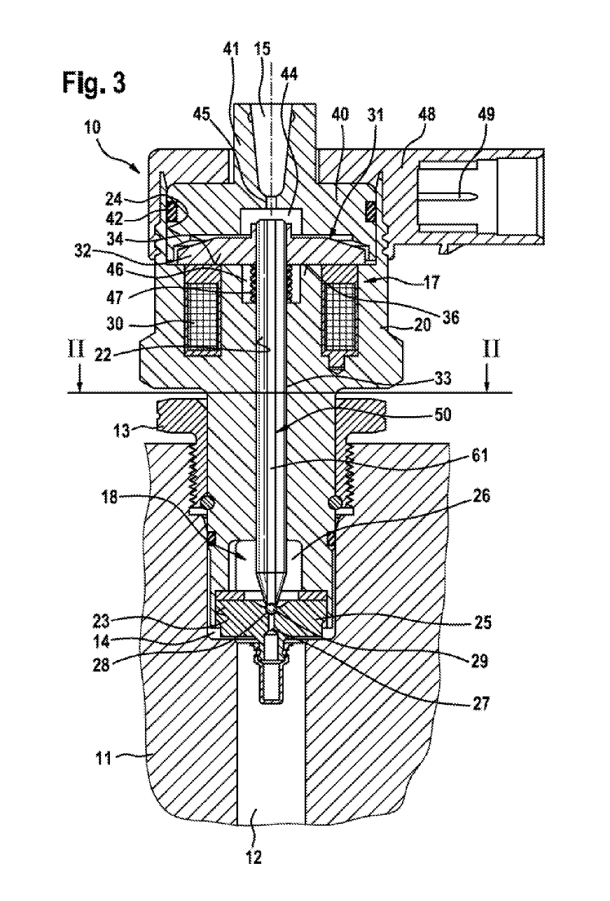

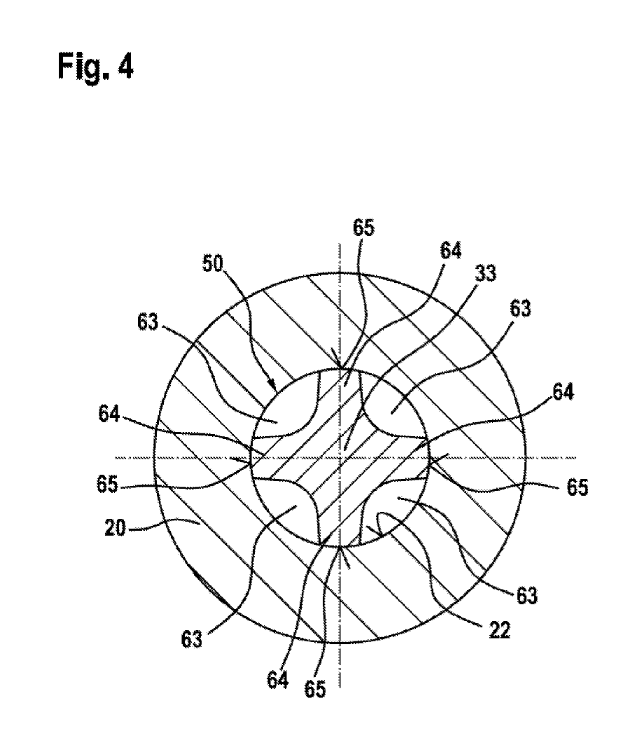

In a further exemplary embodiment, the hydraulic return connection 50 is implemented as at least one channel worked into the piston guide 22 and/or into the armature pin 33, which channel is formed according to FIG. 3 by an axially disposed groove 61 worked into the armature pin 33. In an embodiment according to FIG. 4, the channel is implemented as four grooves 63 worked into the armature pin 33, which are disposed on the surface of the armature pin 33 and thereby establish, via the piston guide 22 and the armature pin 33, the hydraulic return connection 50 between the valve chamber 26 via the spring chamber 46 to the armature chamber 44. The four axially disposed grooves 63 are distributed uniformly around the circumference of the valve piston 33. A land 64 is implemented between each two adjacent grooves 63, forming with its outer face 65 a guide surface inside the piston guide 22.

1. A pressure regulating valve for opening and closing an outlet of a high-pressure accumulator (12) for a fuel injection device for an internal combustion engine, the pressure regulating valve comprising a valve element (18) which is actuable by a magnetic actuator (17) acting with an armature (31) on a closing element (29) which closes or opens a hydraulic connection from the high-pressure accumulator (12) to a valve chamber (26), the armature (31) comprising an armature plate (32) and an armature pin (33) which is guided in an axially movable manner in a valve housing (20), the armature plate (32) being arranged movably in an armature chamber (44), the valve chamber (26) being connected hydraulically to a low-pressure port (15) and the armature chamber (44) being connected hydraulically to the valve chamber (26) via a return connection (50), characterized in that the return connection (50) is implemented as a connecting bore formed in the armature pin (33) between the valve chamber (26) and the armature chamber (44).

2. (canceled)

3. The pressure regulating valve as claimed in claim 1, characterized in that the connecting bore is implemented as a blind bore (51) and a transverse bore (52) branching therefrom.

4. (canceled)

5. The pressure regulating valve as claimed in claim 1, characterized in that the return connection (50) is formed by at least one channel worked into at least one of a piston guide (22) and the armature pin (33).

6. The pressure regulating valve as claimed in claim 5, characterized in that the channel is formed by at least one axially disposed groove (61) worked into at least one of the piston guide (22) and the armature pin (33).

7. The pressure regulating valve as claimed in claim 6, characterized in that four axially disposed grooves (64) are formed in the armature pin (33) and are distributed uniformly around a circumference thereof.

8. The pressure regulating valve as claimed in claim 7, characterized in that a land (65) is implemented between each two adjacent grooves (64) and forms with its outer face (66) a guide surface inside the piston guide (22).

9. The pressure regulating valve as claimed in claim 1, characterized in that the low-pressure port (15) is connected to the armature chamber (44).

10. The pressure regulating valve as claimed in claim 9, characterized in that an outlet throttle (45) is connected downstream of the armature chamber (44) and in that the outlet throttle (45) is formed in a connecting flange (41) of a connecting piece (40).

11. The pressure regulating valve as claimed in claim 8, characterized in that the low-pressure port (15) is connected directly to the valve chamber (26).
